(19) United States
(12) Patent Application Publication
(10) Pub. No.: US 2014/0049064 A1
(43) Pub. Date: Feb. 20, 2014

(54) Knock-down construction of carnival style food cart or stand

(71) Applicant: Zhipeng He, Guangzhou (CN)

(72) Inventor: Zhipeng He, Guangzhou (CN)

(21) Appl. No.: 13/589,091

(22) Filed: Aug. 18, 2012

(51) Int. Cl. B62B 5/00

(52) U.S. Cl. CPC B62B 5/00
USPC 296/29

(57) ABSTRACT

A knock-down cart has a generally square box-like structure having four side panels and at four columns of vertically ledges, with two or four functional or nonfunctional wheels. It serves as elevation base for food machines like popcorn machine and cotton candy floss machine and alike. The knock-down version has a detachable bottom plate of the box-like body which offers easy assembly work for end consumers to put together as well as saves packing cubic the results in cost reduction in shipping and storage.

### BACKGROUND OF THE INVENTION

1. Field of Invention

This stamped metal plate with bent-down corner legs as screw anchor offers easy ready to assemble way for end consumers to put the cart together. This stamped metal plate also offers support and stability to hold the box-like cart body to its legs.

More importantly, this detachable stamped metal plate as bottom side of box-like cart body, allows the top unit (machine) to nest into body cavity which saves up to 60% in total shipping and storage costs.

2. Description of Prior Art

Carnival style carts are common in commercial use as well as for home entertainment. Some carts packed and shipped assembled and some are simi-knockdown. The invention presented here not only maximizes knock-down possibility of carnival style food cart or stand alike in terms of friendly home assembly and compact packaging, but also offers overall stability of food carts in operation.

### SUMMARY OF THE INVENTION

The purpose of the invention by means of allowing the cart and top unit to nest with a detachable stamped metal bottom late is to provide a perfect knock-down version in the industry for carnival style food carts. A well designed KD version promotes energy as well as cost saving to reduce our carbon footprints on this green planet ours.

### BRIEF DESCRIPTION OF THE DRAWINGS

FIG. 1, (A) has this claimed removable metal bottom piece (2) with each corner bent-down vertical leg (5) serving as the connection of box-like cart body to its four vertical legs (4) when they are assembled (B). Once two wheels are installed, the box-like cart serves as elevation base for food machines.

FIG. 2, (A) box-like cart body (2) allows the top unit (1) to nest into (B) which takes up two packing foams (C) for rest body parts (D) to be compacted and protected (E) into shipping carton for transportation

I claim;

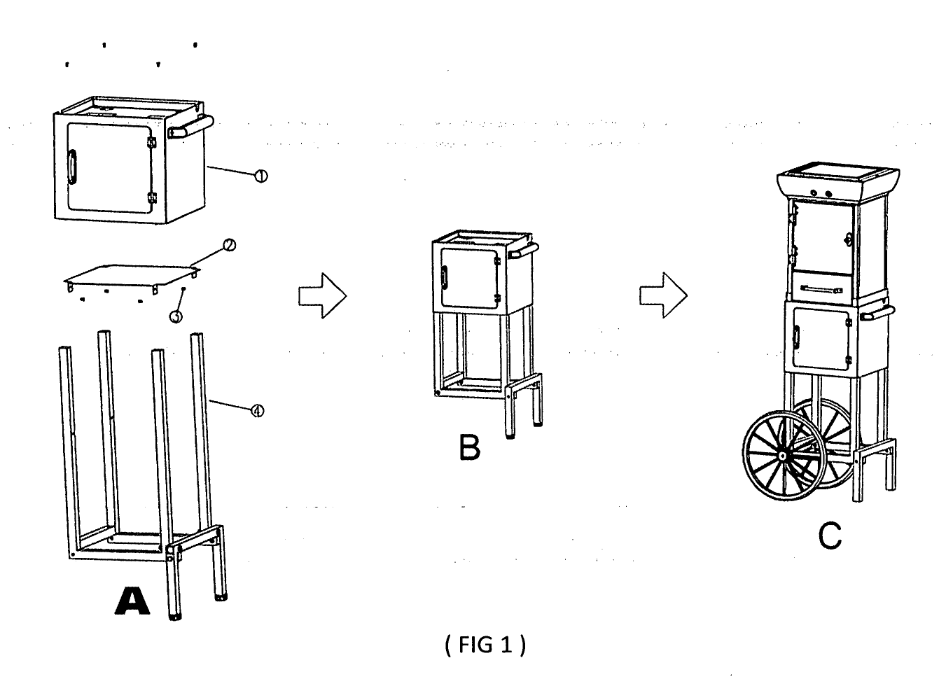

1. (FIG. 1) A, a cart structure comprises (1) a stamped metal sheet with each corner having (2) a bent-down vertical screw anchor and (3) a screw

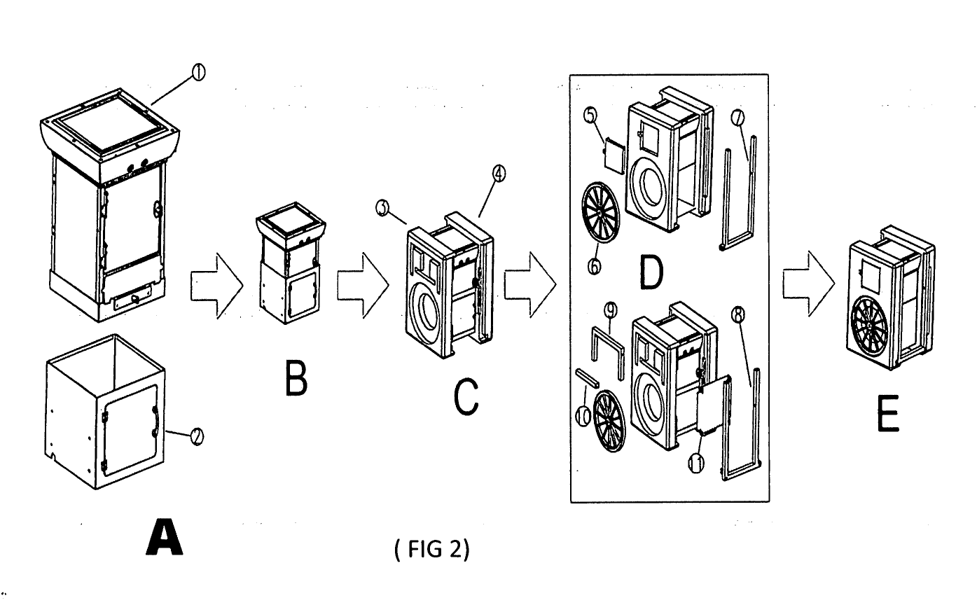

2. (FIG. 2) A, a box-like cart body comprises (2) an open side allowing (1) a top unit machine which sits on to this cart when assembled to nest into for packaging
